(19) United States
(12) Patent Application Publication
(10) Pub. No.: US 2016/0169603 A1
(43) Pub. Date: Jun. 16, 2016

(54) METHOD AND SYSTEM FOR IDENTIFICATION OF THE USER OF A FIREARM DUE TO UNIQUE SIGNATURE MEASURED BY FIREARM SENSOR TELEMETRY

(71) Applicant: Yardarm Technologies, Inc., Capitola, CA (US)

(72) Inventors: Robert J. Stewart, Soquel, CA (US); David Glowacki, San Francisco, CA (US); James Schaff, Pacifica, CA (US); Kyle Howell, Atlanta, GA (US)

(21) Appl. No.: 14/970,112

(22) Filed: Dec. 15, 2015

Related U.S. Application Data
(60) Provisional application No. 62/092,167, filed on Dec. 15, 2014.

(51) Int. Cl. F41A 17/06; G01P 15/08; H04W 4/00; F41A 35/00

(52) U.S. Cl. CPC F41A 17/063; F41A 35/00; G01P 15/0802; H04W 4/008

(57) ABSTRACT

Disclosed herein are devices/apparatuses, systems, methods, and machine readable media for implementing and using a system for identifying an individual who discharged a firearm, and for recording, assessing, identifying, and transmitting information related to the firing of a firearm. More specifically, the present invention relates to firearm telemetry, and includes assessing the predictive nature of a trigger-pull and associated activities, which are unique to individual users when firing a weapon. Using the techniques described herein, it is possible to uniquely identify the individual that fired a firearm.

### CROSS-REFERENCE TO RELATED APPLICATIONS

This application claims the benefit of U.S. Provisional Application No. 62/092,167, filed Dec. 15, 2014, which is incorporated by reference in its entirety.

### FIELD OF THE INVENTION

The present invention relates to apparatuses, systems, computer readable media, and methods for providing services concerning identifying the individual who discharged a firearm based on data from a firearm telematics sensor.

### BACKGROUND

In some circumstances, a firearm has been discharged, but the person who operated the firearm is unknown. For example, an identified firearm may have been used to injure a person or to cause property damage, but there are no witnesses to the event. In some cases, a person may be accused of firing the weapon, but the accused person disputes this. In such circumstances, it would be advantageous to have a way to identify whether a candidate operator is likely to have fired the weapon, or to exclude the candidate operator.

There is a need for devices and systems, including firearm telematics sensors, that facilitate such an identification. Disclosed herein are embodiments of an invention that address those needs.

### BRIEF DESCRIPTION OF THE DRAWINGS

The aspects and advantages of the invention will become more apparent upon consideration of the following detailed description, taken in conjunction with the accompanying drawings, in which like reference characters refer to like parts throughout, and in which:

FIG. 1 shows views of exemplary holster telematics sensors, in accordance with some embodiments of the invention;

FIG. 2 shows views of a system containing an exemplary firearm telematics sensor, in accordance with some embodiments of the invention;

FIG. 3 shows diagrams concerning measurements by a firearm telematics sensor, in accordance with some embodiments of the invention;

FIG. 4 shows a block diagram of a device that may embody a telematics sensor, in accordance with some embodiments of the invention;

FIG. 5 shows views of an exemplary holster telematics sensor, in accordance with some embodiments of the invention;

FIG. 6 shows views of an exemplary holster telematics sensor, in accordance with some embodiments of the invention;

FIG. 7 is a block diagram showing exemplary data flows for an exemplary system, in accordance with some embodiments of the invention;

FIG. 8 shows four exemplary user interfaces for use in a system including control and display of data collection relating to firearm activity, in accordance with some embodiments of the invention;

FIG. 9 shows an exemplary user interface for use in a system including control and display of data collection relating to firearm activity, in accordance with some embodiments of the invention;

FIG. 10 shows an exemplary user interface for use in a system including control and display of data collection relating to firearm activity, in accordance with some embodiments of the invention;

FIG. 11 is a flow chart depicting an exemplary method for identifying an individual who discharged a firearm, in accordance with some embodiments of the invention;

FIG. 12 is a block diagram showing an exemplary mobile computing device, consistent with some embodiments of the invention;

FIG. 13 is a block diagram showing an exemplary computing device, consistent with some embodiments of the invention;

FIG. 14 is a block diagram showing an exemplary computing system, consistent with some embodiments of the invention.

FIG. 15 is an exemplary data set associated with discharge of a firearm, consistent with some embodiments of the invention.

FIG. 16 is an exemplary data set associated with discharge of a firearm, consistent with some embodiments of the invention.

### DETAILED DESCRIPTION

Disclosed herein are devices/apparatuses, systems, methods, and machine readable media for implementing and using a system for identifying an individual who discharged a firearm, and for recording, assessing, identifying, and transmitting information related to the firing of a firearm. More specifically, the present invention relates to firearm telemetry, and includes assessing the predictive nature of a trigger-pull and associated activities, which are unique to individual users when firing a weapon. Using the techniques described herein, it is possible to uniquely identify the individual that fired a firearm. Systems configured according to embodiments of the present invention may thus find application in the forensic analysis of firearm discharges.

As used herein, a “firearm” refers to a ranged weapon, including a handgun, rifle, Taser®, Conducted Electrical Weapon (CEV), or additional types of weapons capable of firing a bullet. Certain embodiments of the disclosure may be specifically adapted for one or more of handguns, rifles, or Tasers.

As used herein, a “telematics sensor” refers to a device for detecting and/or recording information derived from the environment of the device, and where the device has two-way wireless communications capability.

Firearm telemetry is a new field of forensic analysis. Sensor circuitry may be embedded within a firearm such that the presence of the circuitry is transparent to (i.e., does not interfere with) the normal operation of the firearm but which is configured to transmit data concerning the operation of the firearm in real-time to a command or dispatch center for real time mapping, observation of certain, perhaps mission-critical, events, (e.g., un-holstering, direction of aim, and firing), and other applications.

Using firearm telematics sensors embedded within firearms to capture and relay information concerning the firing event and through subsequent scrutiny of that information, the present inventors have determined that, in some embodiments, by analyzing the information (represented in the form of a three-axis waveform) one can uniquely determine the identity of the individual that fired the firearm. That is, the present inventors have determined that each individual firing the same firearm under similar circumstances does so in a manner that creates a unique data signature associated with the predictive nature of the individual's trigger pull. For example, just before firing, an individual's trigger finger begins to move very slightly in a tensing fashion in preparation for (or anticipation of) the firearm's recoil. How each person's trigger finger squeezes the trigger and then relaxes is also unique, and can be recorded and relayed as a firearm sensor data transmission. This trigger-pull “finger print,” if you will, can be stored in a database for subsequent use, e.g., comparison with an unknown trigger pull finger print as part of a forensic investigation.

In certain embodiments, unholstering of a firearm (as detected by a holster telematics sensor) “wakes up” a firearm telematics sensor from standby or low-power mode, and causes the firearm telematics sensor to switch over to an active state, and may initiate detection or recording of data (including, for example, inertial measurements) by a firearm telematics sensor. The recording may be saved locally at the firearm telematics sensor and/or may be transmitted to another device where it is stored.

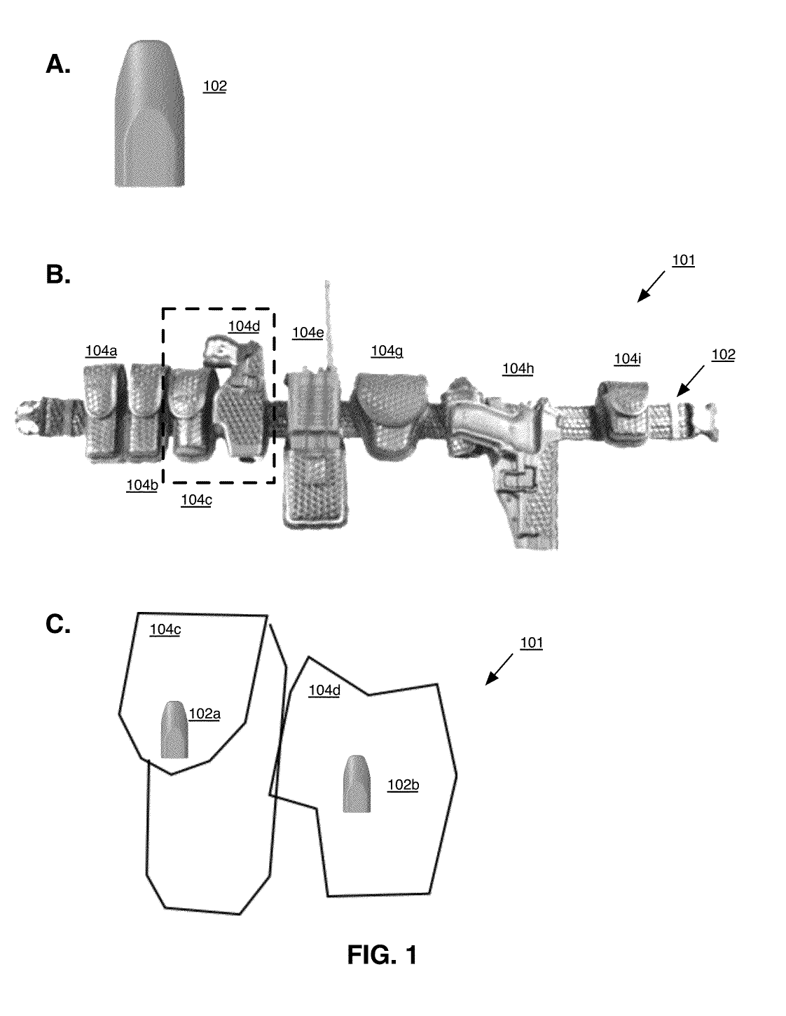

FIG. 1 shows views of exemplary holster telematics sensors 102. FIG. 1A shows an isolated exemplary holster telematics sensor 102. FIG. 1B shows components of an exemplary system 101 that makes use of holster telematics sensors 102. System 101 includes a utility belt 102 with attached holsters 104a-i. Each of holsters 104a-i may incorporate a holster telematics sensor 102, for use in detecting when an instrument, such as a firearm, pepper spray, baton, handcuffs, or a radio, is present or absent from the respective holster 104. As shown in FIG. 1C, for example, holsters 104c and 104d from system 101 may each be associated with a respective holster sensor 102. A holster sensor 102 may be attached to a flap of holster 104, or may be attached to the exterior of holster 104, or may be integrated between or within the materials of holster 104.

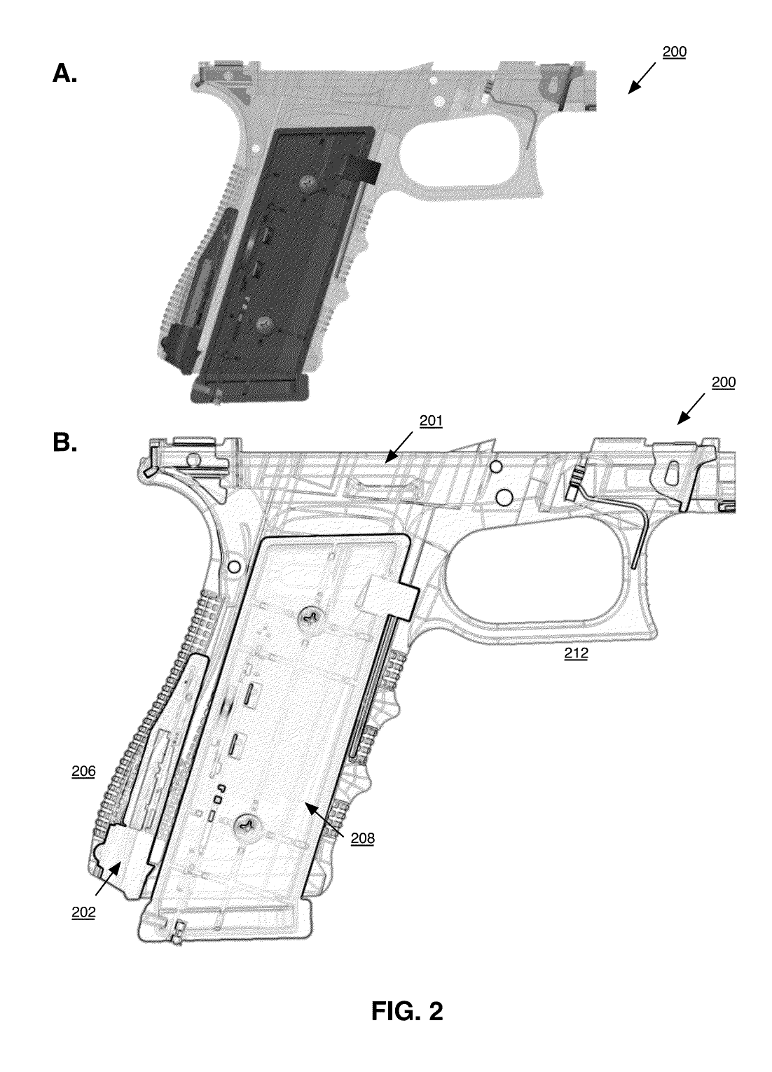

FIG. 2 shows views of a system 200 containing an exemplary firearm telematics sensor 202. Firearm telematics sensors may be associated with a firearm, for example, through attachment to a firearm, or they may be integrated within the firearm. In certain embodiments, more than one firearm telematics sensor may be associated with the same firearm, and may be measuring different types of data or aspects of the environment. As shown in FIG. 2B, firearm telematics sensor 202 may be integrated into the grip 206 of a handgun 201. In certain embodiments, firearm telematics sensor 202 may be mounted to the slide or sight, or the trigger guide 212 of handgun 201. In certain embodiments, firearm telematics sensor 202 may be charged by a charging device 208 that may be inserted into the magazine chamber of handgun 201. In certain embodiments, a firearm telematics sensor 202 may be used to detect, for example, one or more of: ambient temperature, location; inertial measurements including firearm movement, translation, and bearing; and events such as discharge of a weapon (e.g., firing a bullet) and holstering or unholstering of the firearm. Such detection is described in more detail below.

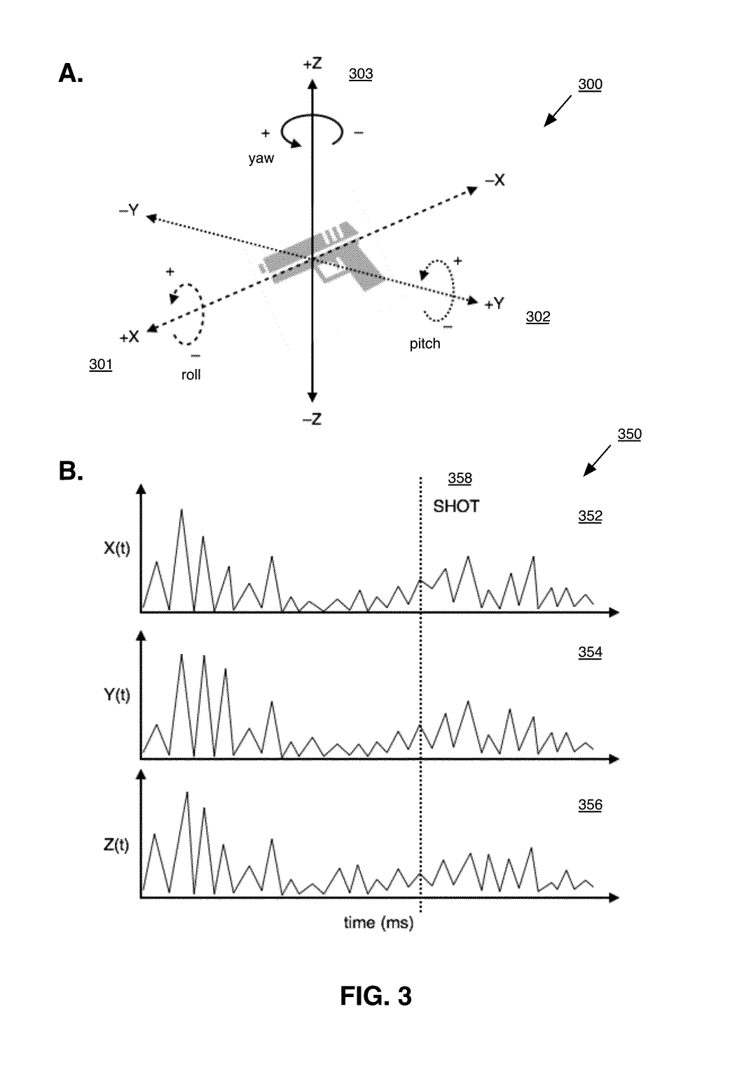

FIG. 3 shows exemplary diagrams concerning measurements by a firearm telematics sensor 202. In certain embodiments, a firearm telematics sensor 202 may be used to detect and/or record measurements related to a firearm. For example, a firearm telematics sensor 202 may wake up from standby upon unholstering of the associated firearm. In some examples, unholstering may be detected by a separate holster telematics sensor 102, e.g., mounted on a holster, that in turn contacts a firearm telematics sensor 202, causing sensor 202 to change to a more active state in which it has additional or full functionality with respect to detection. In some examples, unholstering is detected by the firearm telematics sensor 202.

In some embodiments, a firearm telematics sensor 202 may be capable of detecting inertial measurements such as the movements depicted in the system 300 with a firearm shown at the origin of the axes as depicted in FIG. 3A. As shown, the firearm may be translated along three dimensional axes: X (301), Y (302), and Z (303). Measurements concerning translation may be captured as position, velocity, and/or acceleration. In certain embodiments, such measurements may be inferred from measurements of directional acceleration, for example by integrating the acceleration or performing other inferential calculations; in some embodiments translation is directly detected.

A firearm may also be rotated, and measurements of rotation within system 300 may be detected as roll (e.g., rotation around X axis 301), pitch (e.g., rotation around Y axis 302), and yaw (e.g., rotation around Z axis 303). The absolute orientation of a firearm (e.g., detected as a compass bearing) may also be detected by certain embodiments of a firearm telematics sensor (e.g., resulting in measurements such as N76° E, referring to the direction the barrel is pointed toward—i.e., the direction of aim; along the positive X axis in FIG. 3A). In certain embodiments, a firearm's global location may be detected by, e.g., a firearm telematics sensor 202, or another component of the systems described here, and that location may be recorded in decimal degrees with respect to the Prime Meridian and equator—e.g., 38.889722°, −77.008889° or in terms of cardinal coordinates such as 38° 53′ 35″ N, 77° 00′ 32″ W.

In certain embodiments, inertial measurements such as acceleration, velocity, or displacement of the firearm along a spatial axis may be plotted, such as the exemplary plots shown in FIG. 3B. In one example, the plots 350 shown in FIG. 3B may represent the absolute value of the acceleration in terms of standard gravity (g, 9.8 m/s²) along the X, Y, and Z spatial axes of system 300 during a time window that includes discharge of the firearm. A time point corresponding to the firearm discharge is marked using a dashed line 358. In other examples, X(t) shown in plot 352 may represent the magnitude (e.g., an unsigned scaled value C*acceleration) of acceleration, velocity, or lateral displacement along X axis 301, or the rotational acceleration about X axis 301, or a combination of the lateral and rotational acceleration (or velocity, or displacement) with respect to X axis 301. Plots 354 and 356, representing Y(t) and Z(t) may represent corresponding functions concerning the other two spatial dimensions. In certain embodiments, three plots representing a weapon discharge (e.g., X(t), Y(t), Z(t) of plots 350) may constitute all or part of a firearm signature that represents a particular individual's characteristic pattern of firing a weapon under similar conditions.

In certain embodiments, the inertial measurements and other measurements may be associated with a time point. Firearm telematics sensor 202 may have an internal clock to relate each measurement along a time point, or in certain embodiments the measurements are related by their order in time, and may be associated with a time point at another component of the systems of the invention.

In some embodiments, when active, firearm telematics sensor 202 may scan each data series (e.g., raw data such as acceleration measurements, or one or more of X(t), Y(t), and Z(t)) to identify windows of time that represent a firearm discharge (e.g., as distinguished from dropping the firearm, running while carrying the firearm, or unholstering the firearm). A discharge event may be associated with a characteristic pattern that is generally associated with firing of a weapon, and more specifically associated with a particular person's signature when firing a particular make and model of firearm under similar conditions. Stated another way, in some embodiments, the firearm telematics sensor 202 is able to diagnose whether a shot has been fired, and firearm telematics sensor 202, or another component may conduct a finer level of classification concerning whether the same person fired a type of weapon, of if a different person fired the type of weapon.

Similar conditions may refer to, for example: firing of a firearm having the same make and model; firing of a firearm of the same category of firearm (e.g., a handgun vs. a rifle); firing of a firearm where the operator is under a similar level of physical and/or emotional stress—e.g., weapon fired immediately after operator has jogged 500 feet vs. weapon fired without any physical activity.

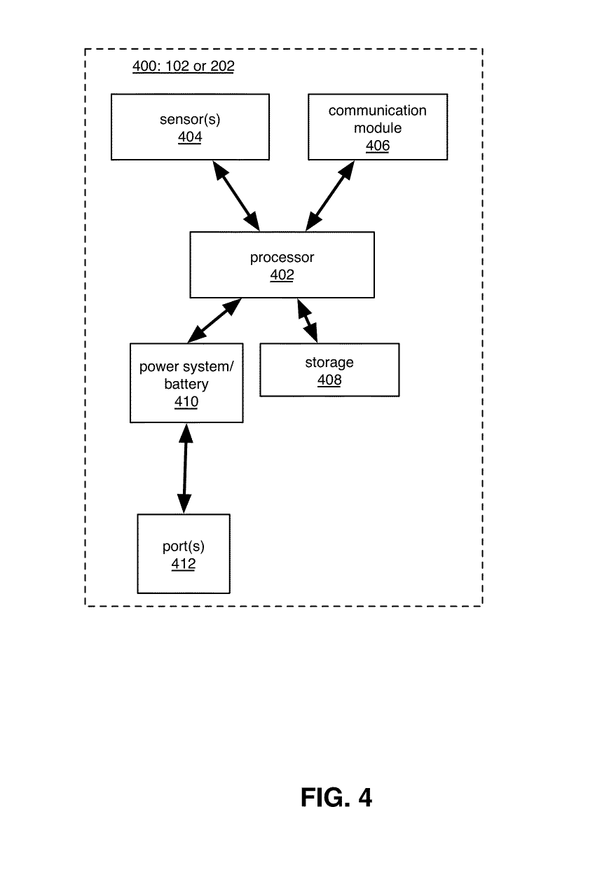

FIG. 4 shows a block diagram of a device 400 that may embody a telematics sensor (e.g., holster telematics sensor 102 or firearm telematics sensor 202). Device 400 includes a processor 402 that may be in communication with one or more sensors 404, a communication module 406, a storage component 408, and a power system and/or battery 410. The power system/battery 410 may be in communication with one or more port(s) 412.

Device 400 may include one or more sensors 404—e.g., a temperature sensor for monitoring thermal load or ambient temperature, an accelerometer, a magnetometer, a gyroscope, a metal sensor (e.g., pulse induction sensor components), optical/light sensor, microphone, etc. Communication module 406 may include a subscriber identity module (SIM) card, cellular radio, Bluetooth radio, ZigBee radio, Near Field Communication (NFC) radio, wireless local area network (WLAN) radio, GPS receiver, and antennas used by each for communicating data over various networks. Storage 408 may include one or more types of computer readable medium, such as RAM, optical storage devices, or flash memory, and may store an operating system, applications, and communication procedures. The power system/battery 410 may include a power management system, one or more power sources such as a battery and recharging system, AC, DC, a power status indicator, and the like

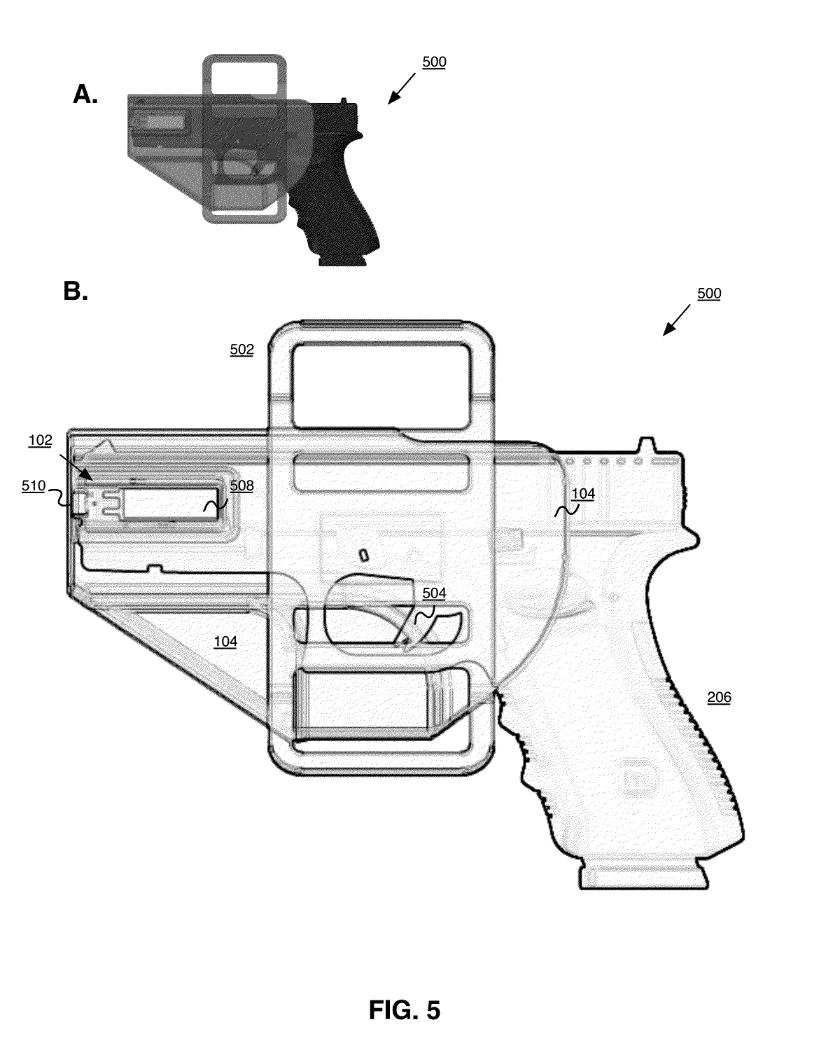

FIG. 5 shows views of an exemplary holster telematics sensor system 500, including a holster telematics sensor 102 attached to a holster 104 having a belt clip 502, and where the holster 104 is shown to contain a holstered handgun with trigger 504 and grip 206. Holster telematics sensor 102 may include a battery 508 and a port 510. Port 510 may be, e.g., a Universal Serial Bus (USB) port, a microUSB port, a Lightning™ port, and the like.

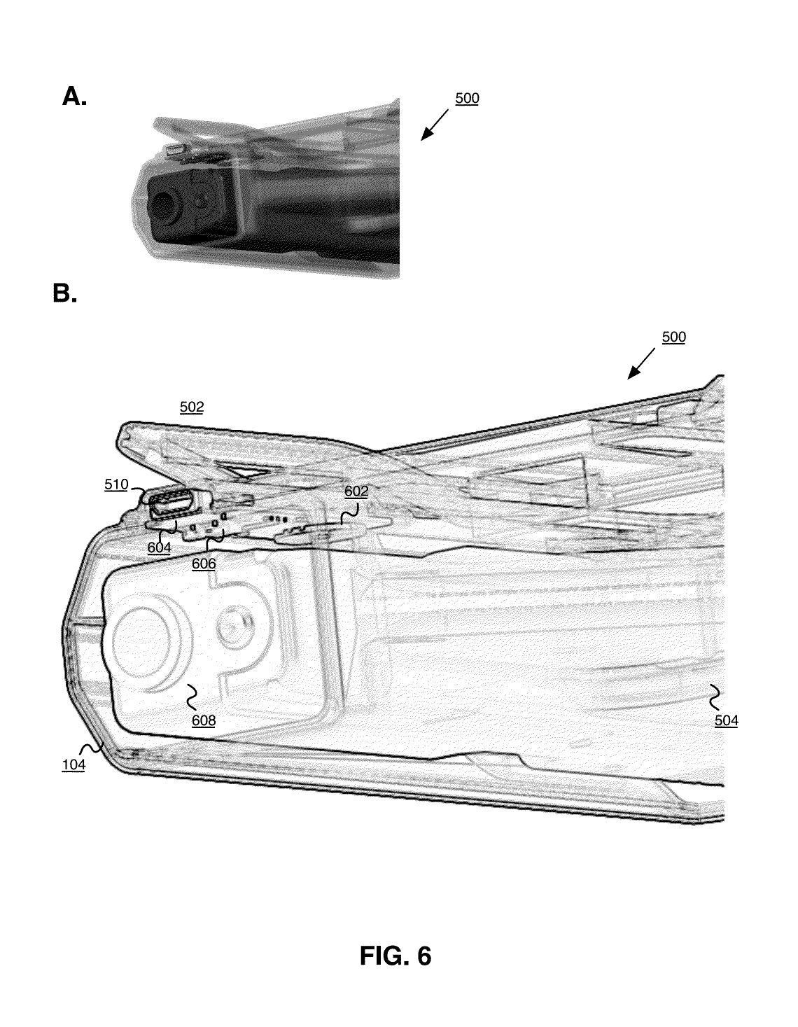

FIG. 6 shows views of an exemplary holster telematics sensor system 500. FIG. 6B shows a rotated view of the system 500 shown in FIG. 5. In the embodiment shown here, holster telematics sensor 102 includes a pulse induction coil 602 mounted on circuit board 604 with companion circuitry 606 for detecting the presence of a firearm based on the presence of the metal of the firearm (e.g., the receiver, muzzle 608, etc.). In other examples, holster telematics sensor 102 may use very low frequency (VLF) technology to detect whether a firearm is present based on the presence of metal, or components to measure the dielectric change when metal is present or absent, NFC to communicate between sensors on a firearm and a holster, or a light sensor to detect whether light is absent, indicating a firearm is holstered.

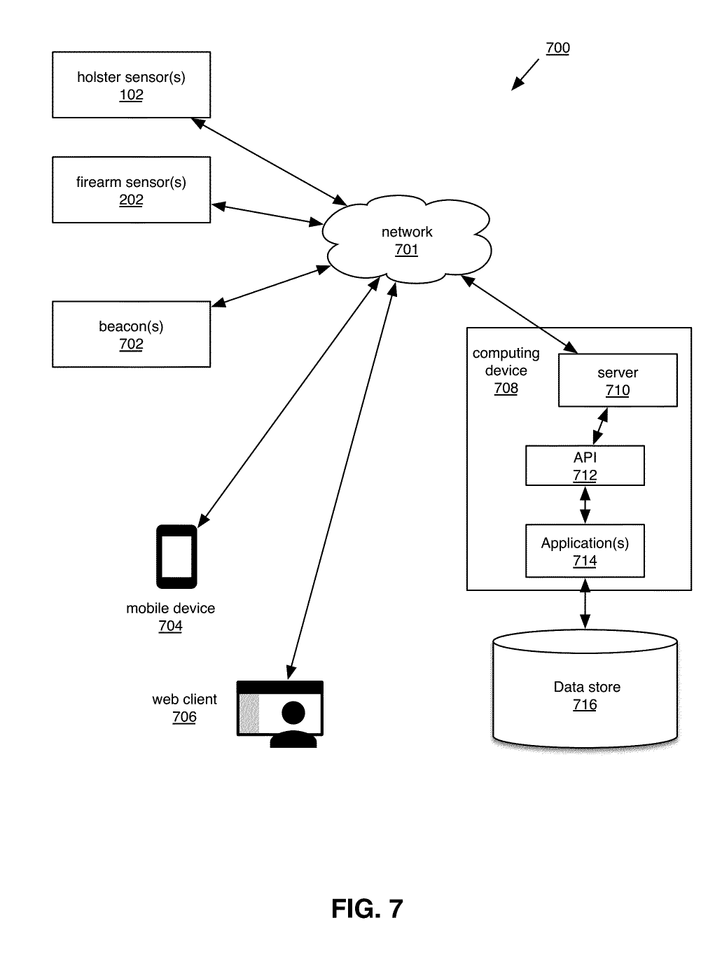

FIG. 7 is a block diagram showing exemplary data flows for an exemplary system 700. In certain embodiments, data regarding the status of a component of system 700 and or the environment of system 700 (including, for example, a firearm and a holster) may be generated at holster telematics sensor(s) 102, firearm telematics sensor(s) 202, beacon 702, and/or mobile device 704. In certain embodiments, this data may be shared between components of the system (e.g., holster telematics sensor(s) 102, firearm telematics sensor(s) 202, beacon 702, and/or mobile device 704) on a local area network such as a Bluetooth or ZigBee even in the absence of a wireless connection providing communication with geographically remote devices (e.g., the device executing web client 706 or computing device 708 hosting server 710).

In certain embodiments, beacon(s) 702 may be proximity beacons, such as devices using the Google Eddystone™, iBeacon™, FlyBell™, and/or BLE protocols for monitoring and ranging proximity of components of the system (e.g. holster telematics sensor(s) 102, firearm telematics sensor(s) 202, and/or mobile device 704) with respect to one or more beacons 702. In certain embodiments, one or more beacons 702 may be positioned at a fixed location or a moving location such as a vehicle.

In certain embodiments, mobile device 704 may be a smartphone, a tablet computer, or a radio, such as a police radio, and web client 706 may be executed at a command and control center (e.g., for police, military, or security professionals). All components of the system 700 are directly or indirectly connected using a combination of communication protocols represented by network 701. Network 701 may include a LAN, wired or wireless network, private or public network, or the internet, including wireless communication protocols such as General Packet Radio Service (GPRS), Enhanced Data rates for GSM Evolution (EDGE), 3G, 4G, Long Term Evolution (LTE) protocols, and communication standards such as Project 25 (P25), Terrestrial Trunked Radio (TETRA), and satellite and/or field radio protocols.

In certain embodiments, one or more computing devices 708 hosts a server 710, such as an HTTP server, and an application 714 that implements aspects of the remote monitoring system (e.g., a situational intelligence platform). For example, status-related files, firearm signatures, and/or user account information may be stored in data store 716. Application 714 may support an Application Programming Interface (API) 712 providing external access to methods for accessing data store 716. In certain embodiments, client applications running on on client devices 102, 202, 702, 704, and 706 may access API 712 via server 710 using protocols such as HTTP or FTP.

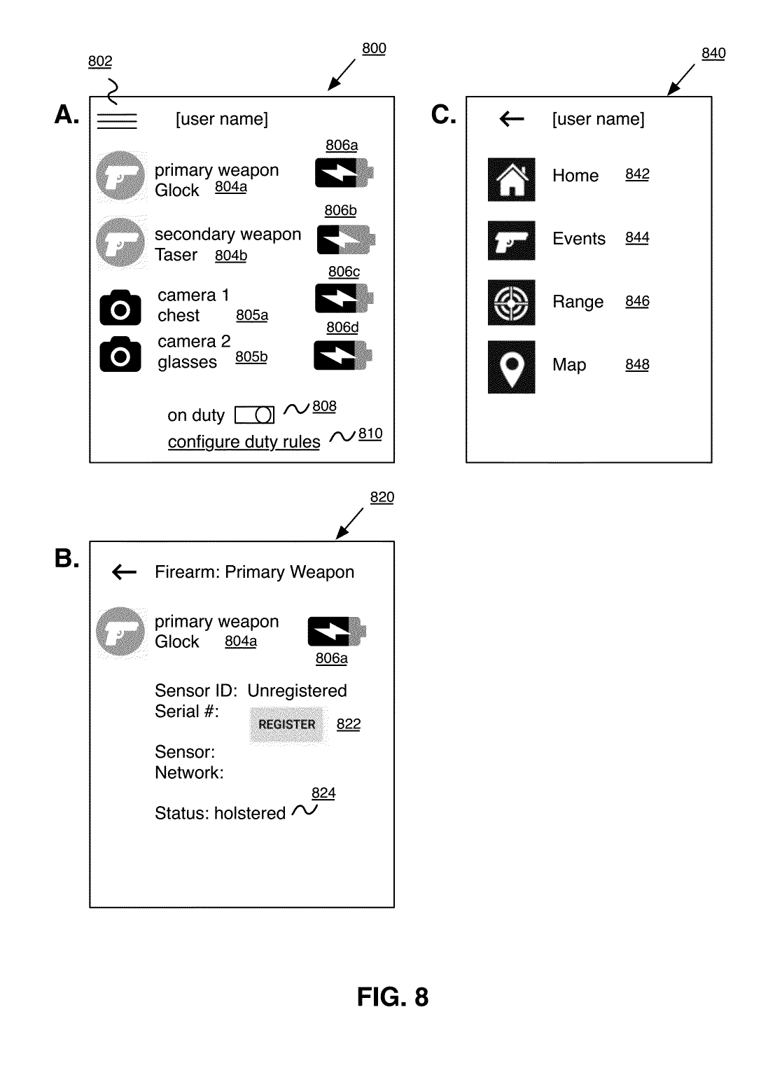

FIG. 8 shows three exemplary user interfaces for use in a system including camera control relating to firearm activity. FIG. 8A shows a user interface 800 displaying a list of firearms 804 and cameras 805 available in a firearm remote monitoring system. In one embodiment of such a system, each firearm 804 is associated with a battery-powered accessory device (e.g., firearm telematics sensor 202), and the status of the battery for each device is shown using icons 806. Icons 806 may also be used to represent the remaining battery life for the respective cameras 805. As shown, the accessory device associated with firearm 804a has greater charge remaining than firearm 804b. User interface 800 further includes an on-duty toggle 808 to control whether the system should monitor the associated firearms in “on duty mode” vs. “off duty mode”. For example, a user may desire a different rule set to apply with respect to gathering firearm inertial data and other data while the user is on duty vs. off duty—for example, a user may desire to have an associated firearm telematics sensor 202 not be activated while the user is off duty, because the firearm may not be in use and deactivating sensor 202 may preserve battery life. User interface 800 may include a link to a settings menu 810 allowing the user to configure rules for on- and off-duty states. User interface 800 may further provide a drop-down menu 802 to access additional options, e.g., user interface 840 shown in FIG. 8C.

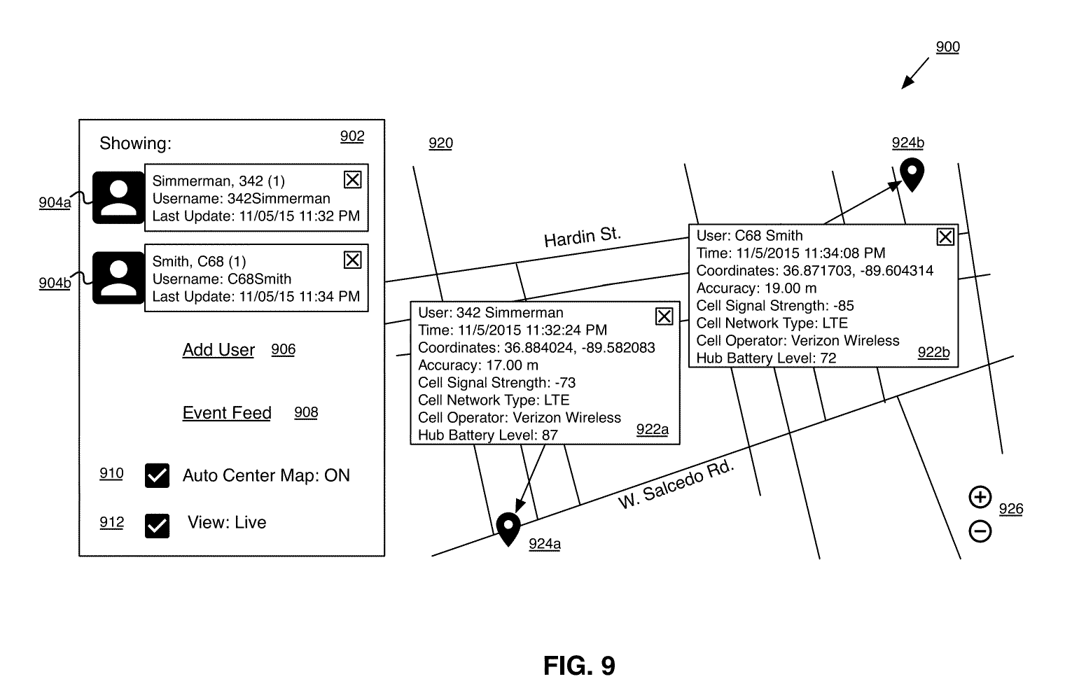

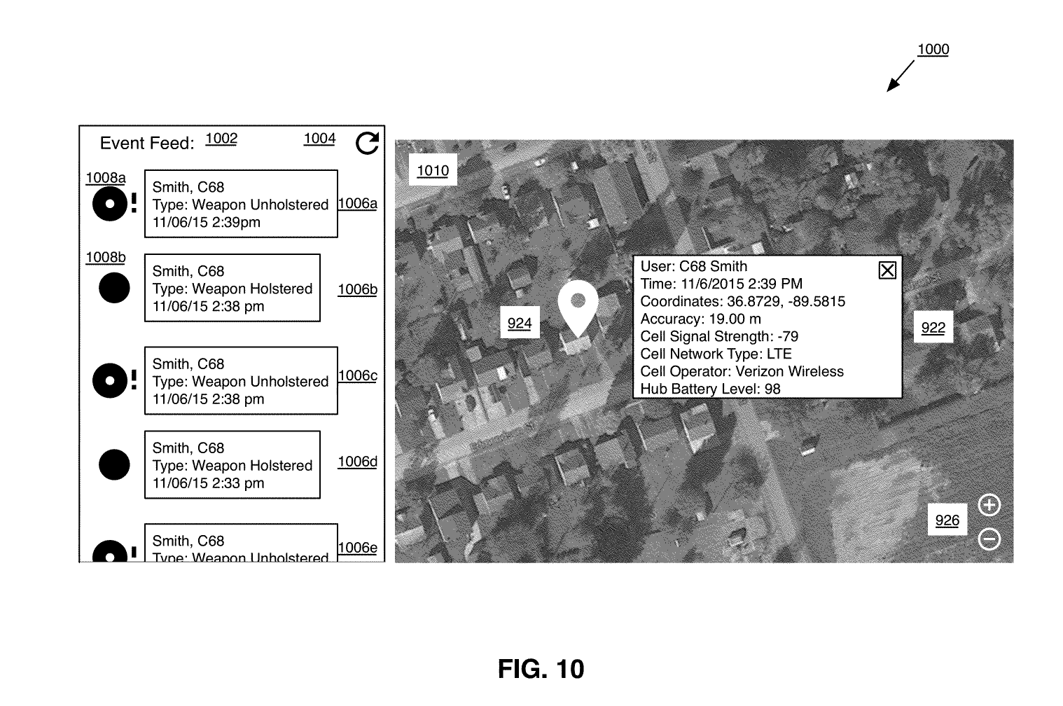

In some embodiments, selecting a particular firearm 804 in user interface 800 may display user interface 820, shown in FIG. 8B. User interface 820 may be used to register a firearm telematics sensor 202 upon selecting register button 822. Such an interface may be further modified to display additional information about the charging status for the firearm telematics sensor 202 that is associated with firearm 804a. User interface 820 may also display additional information about a firearm and its associated system components—e.g., firearm telematics sensor 202, charging devices, hub devices. A hub device may be a mobile device that is paired with or local to firearm telematics sensor 202 and/or holster telematics sensor 102, e.g., mobile device 704. For example, the information may include the location of each component plotted on a map, the serial number or ID for the components, the user associated with each component, whether/how each component is connected to a network and/or links to other UIs for displaying such information, such as the interfaces shown in FIGS. 9-10).

FIG. 8C shows an exemplary user interface 840 providing access to a home link 842, an events link 844 (see, e.g., FIG. 10), a range link 846, and a map link 848 for accessing a display of the locations of system components (see, e.g., FIGS. 9-10).

FIG. 9 shows an exemplary user interface for use in a system including control and display of data collection relating to firearm activity. Such an interface may be used for displaying the locations of system components (e.g., a firearm and associated sensors 102 and 202). Panel 902 provides a listing of two users 904a and 904b; components associated with those users are displayed on a map in panel 920. Panel 902 further provides a link 906 to add an additional user to the display, and a link 908 to access an event feed (see FIG. 10). Toggle 910 controls a map centering option and toggle 912 controls whether the display in panel 920 updates to display live information or stops refreshing.

Map panel 920 marks the location of the components associated with the users on the map using location markers 924. The map may be stylized as shown, or may constitute a satellite photograph. A user may adjust the scale of the map using controls 926. Additional information associated with the components at each location 924 is displayed in an overlay window 922. For example, the overlay window 922 provides information about (1) the user associated with the component(s) at the location; (2) the time stamp associated with the information; (3) the coordinates of the location; (4) the accuracy/error estimate for the location; (5) information about the network type, strength, and operator; (6) hub device battery status. In certain embodiments, additional information about camera status could be provided as well.

FIG. 10 shows an exemplary user interface 1000 for use in a system including control and display of data collection relating to firearm activity. User interface 1000 may be used to view an event feed (panel 1002) alongside the locations associated with each event (displayed in panel 1010, showing a satellite image for the map). Panel 1002 may display individual events 1006 (e.g., status change from “Weapon Holstered” to “Weapon Unholstered”, or the reverse, or simply a list of the status for each component being monitored each time it is reported by a hub device or directly from another component such as a holster telematics sensor 102), along with additional information such as the associated user name, a time stamp, and the event type. Events may be associated with icons 1008 to quickly indicate the category of event. An event feed may be manually refreshed using a control 1004—for example, in certain embodiments, this may cause the system to poll each component to report its current status, or in other embodiments, it may update the list of components being tracked and/or displayed in user interface 1000. Events or event types that could be monitored using user interface 1000 in FIG. 10 may be, for example, user exits a vehicle with a firearm, user enters a vehicle with a firearm, holstering a firearm, unholstering a firearm, holstering or unholstering a policing implement such as a radio, discharging a firearm (e.g., discharging a Taser or firing a bullet), approaching a second user of the system, a firearm is separated from the user, loud noise is detected, and receiving a notification from a second user of the system or dispatch or command.

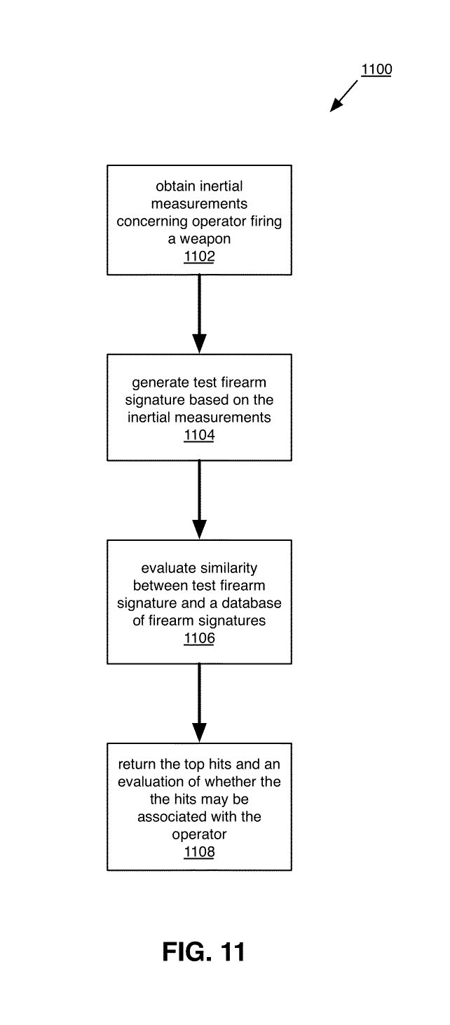

FIG. 11 is a flow chart depicting an exemplary process 1100 for identifying an individual who discharged a firearm. The process begins when one or more firearm telematics sensors 202 obtain inertial measurements for a firearm, and determine that the firearm has been discharged (e.g., by detecting a set of inertial measurements at with a very high magnitude) (1102).

Next, a test firearm signature is generated based on the inertial measurements during the discharge event (1104). E.g., three plots representing a weapon discharge (e.g., X(t), Y(t), Z(t) of plots 350) may constitute all or part of a firearm signature that represents a particular individual's characteristic pattern of firing a weapon under similar conditions. Generating the signature may involve filtering the raw measurements using a band pass filter, or normalizing the data, and/or using other data processing steps.

Next, a database of existing firearm signatures is searched using the test firearm signature. That is, the similarity between the test firearm signature and the signatures in the database is evaluated (1106). Similarity between the signatures may be evaluated using methods such as a least-squares comparison, principal component analysis, or Pearson correlation.

In some embodiments, the entire database of signatures is evaluated, and information about a ranked list of signatures is provided. In some embodiments, only information about the top hits (e.g., the most likely hits to the test signature) is provided (1108). The top hits may be information about the firearm signatures that were more similar than a threshold value of similarity. The threshold value may correspond to a likelihood that the test signature and the top hits are associated with the same firearm operator. In some embodiments, the top hits may represent a greater than 50%, 75%, 90%, 95%, or 99% chance that the operator for the test signature is the same operator associated with the top hits.

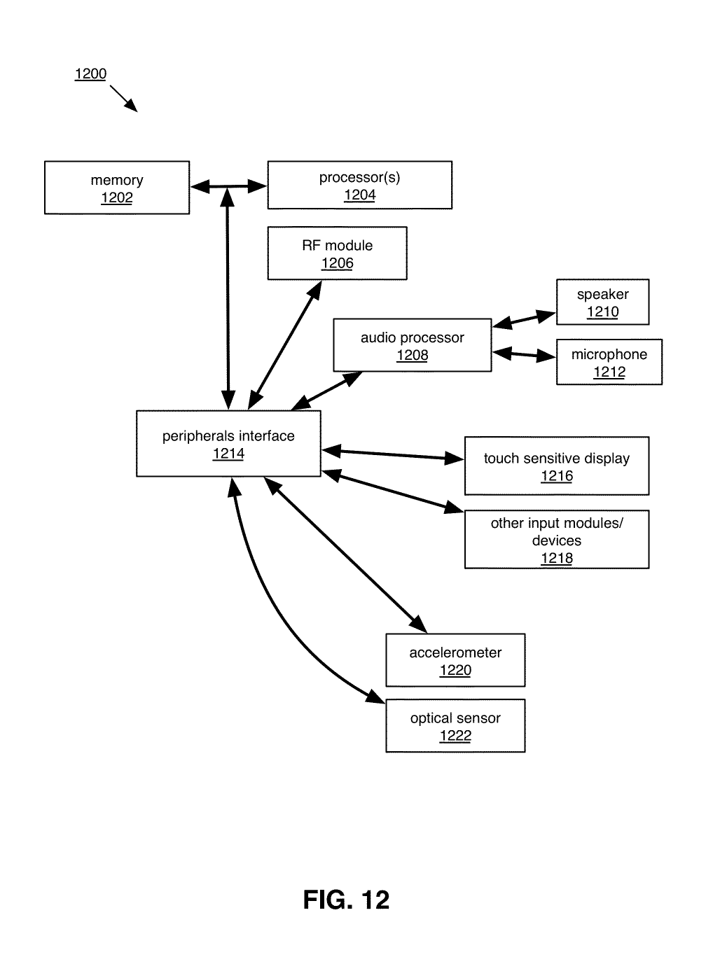

FIG. 12 is a block diagram showing an exemplary mobile computing device (e.g., mobile device 704). The device 1200 may have a memory 1202 which may include one or more types of computer readable medium, such as RAM, optical storage devices, or flash memory. Memory 1202 may store an operating system, applications, and communication procedures. Device 1200 may include one or more data processors, image processors, or central processing units 1204. Device 1200 may include peripherals interface coupled to RF module 1206, audio processor 1208, touch sensitive display 1216, other input modules/devices 1218, accelerometer 1220 and optical sensor 1222.

RF module 1206 may include a cellular radio, Bluetooth radio, NFC radio, WLAN radio, GPS receiver, and antennas used by each for communicating data over various networks.

Audio processor 1208 may be coupled to a speaker 1210 and microphone 1212. Touch sensitive display 1216 receives touch-based input. Other input modules or devices 1218 may include, for example, a stylus, voice recognition via microphone 1212, or an external keyboard.

Accelerometer 1220 may be capable of detecting changes in orientation of the device, or movements due to the gait of a user. Optical sensor 1222 may sense ambient light conditions, and acquire still images and video.

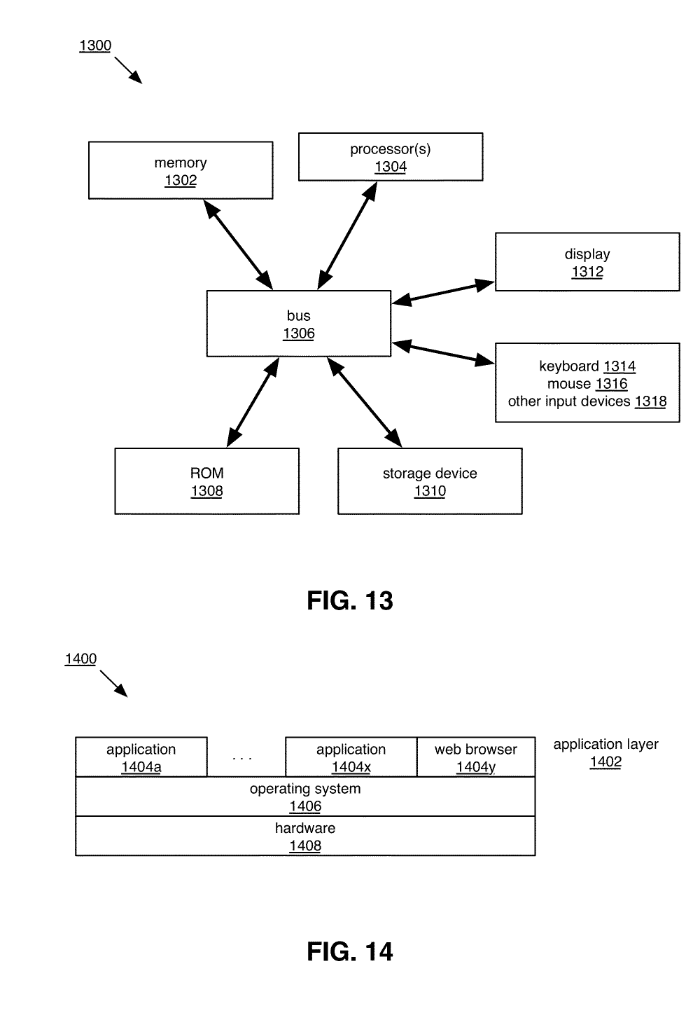

FIG. 13 is a block diagram showing an exemplary computing system 1300 that is representative any of the computer systems or electronic devices discussed herein. Note, not all of the various computer systems have all of the features of system 1300. For example, systems may not include a display inasmuch as the display function may be provided by a client computer communicatively coupled to the computer system or a display function may be unnecessary.

System 1300 includes a bus 1306 or other communication mechanism for communicating information, and a processor 1304 coupled with the bus 1306 for processing information. Computer system 1300 also includes a main memory 1302, such as a random access memory or other dynamic storage device, coupled to the bus 1306 for storing information and instructions to be executed by processor 1304. Main memory 1302 also may be used for storing temporary variables or other intermediate information during execution of instructions to be executed by processor 1304.

System 1300 includes a read only memory 1308 or other static storage device coupled to the bus 1306 for storing static information and instructions for the processor 1304. A storage device 1310, which may be one or more of a hard disk, flash memory-based storage medium, magnetic tape or other magnetic storage medium, a compact disc (CD)-ROM, a digital versatile disk (DVD)-ROM, or other optical storage medium, or any other storage medium from which processor 1304 can read, is provided and coupled to the bus 1306 for storing information and instructions (e.g., operating systems, applications programs and the like).

Computer system 1300 may be coupled via the bus 1306 to a display 1312 for displaying information to a computer user. An input device such as keyboard 1314, mouse 1316, or other input devices 1318 may be coupled to the bus 1306 for communicating information and command selections to the processor 1304.

The processes referred to herein may be implemented by processor 1304 executing appropriate sequences of computer-readable instructions contained in main memory 1304. Such instructions may be read into main memory 1304 from another computer-readable medium, such as storage device 1310, and execution of the sequences of instructions contained in the main memory 1304 causes the processor 1304 to perform the associated actions. In alternative embodiments, hard-wired circuitry or firmware-controlled processing units (e.g., field programmable gate arrays) may be used in place of or in combination with processor 1304 and its associated computer software instructions to implement the invention. The computer-readable instructions may be rendered in any computer language including, without limitation, Objective C, C#, C/C++, Java, assembly language, markup languages (e.g., HTML, XML), and the like. In general, all of the aforementioned terms are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying”, “receiving”, “transmitting” or the like, refer to the action and processes of an appropriately programmed computer system, such as computer system 1300 or similar electronic computing device, that manipulates and transforms data represented as physical (electronic) quantities within its registers and memories into other data similarly represented as physical quantities within its memories or registers or other such information storage, transmission or display devices.

FIG. 14 illustrates a computer system 1400 from the point of view of its software architecture. Computer system 1400 may be any of the electronic devices or, with appropriate applications comprising a software application layer 1402, may be a computer system for use with aspects of the system described herein. The various hardware components of computer system 1400 are represented as a hardware layer 1408. An operating system 1406 abstracts the hardware layer and acts as a host for various applications 1404, that run on computer system 1400. The operating system may host a web browser application 1404y, which may provide access for the user interfaces, etc.

### EXAMPLES

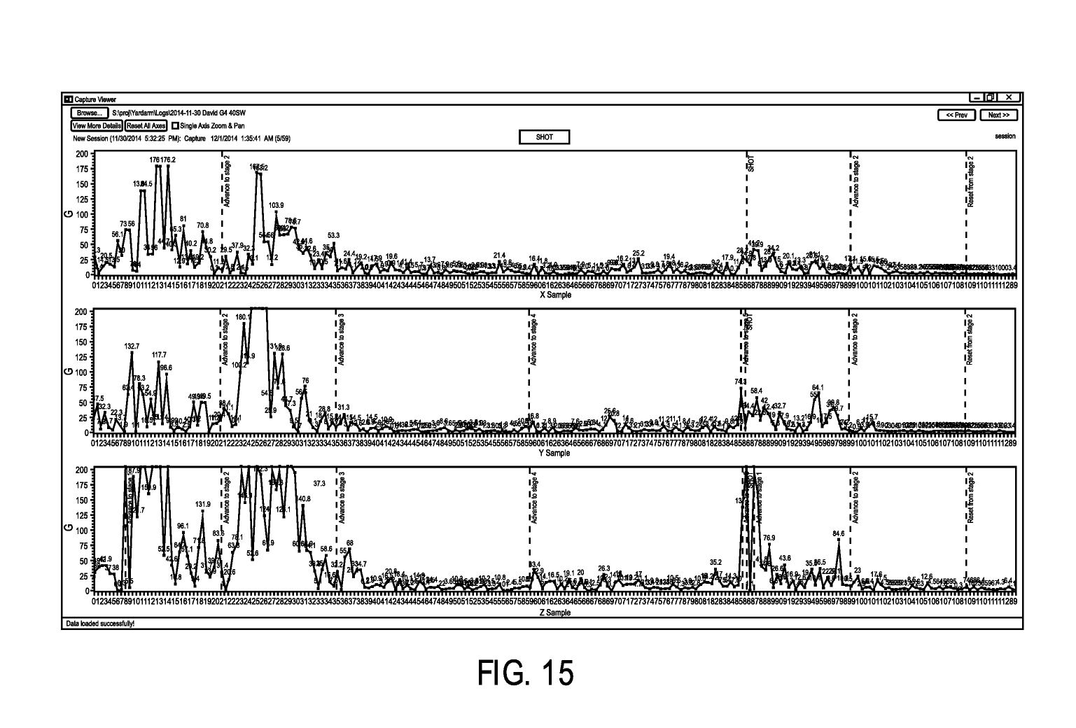

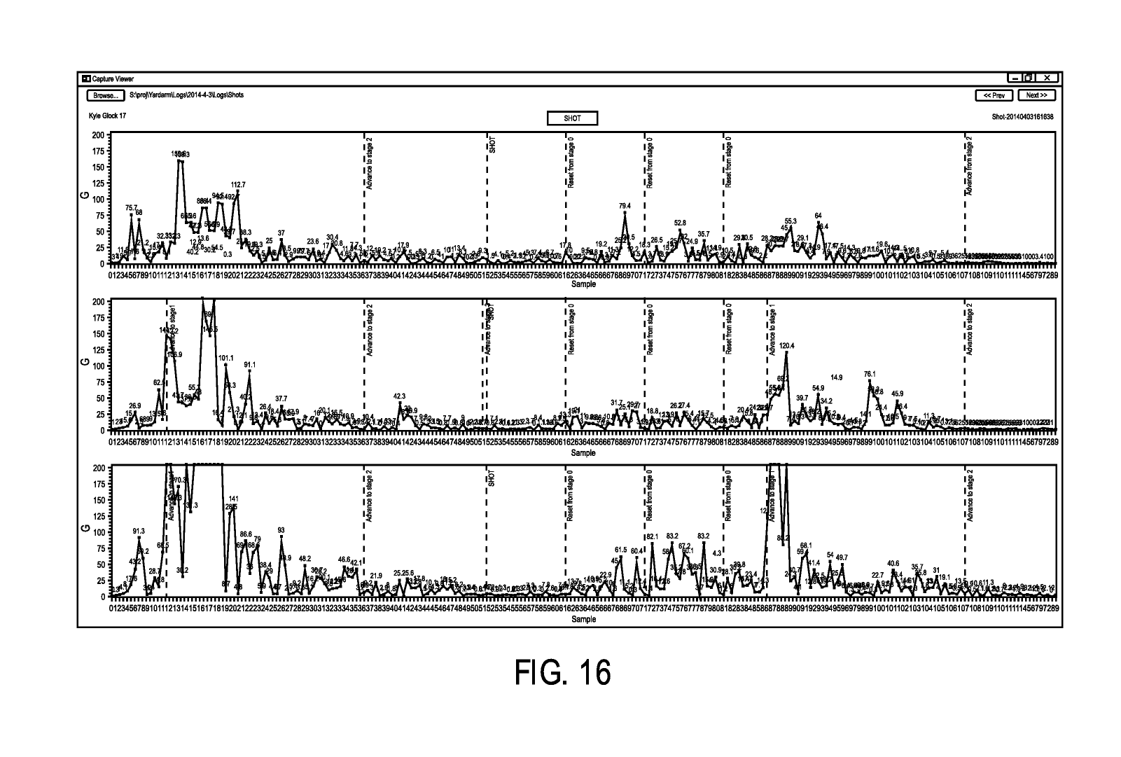

FIGS. 15 and 16 show plots of variables associated with three-axis waveforms of the kind indicative of different individuals' trigger pull finger prints relating to the firing of a firearm by the different individuals under similar circumstances and conditions. In these illustrations an “X-axis” parameter is represented in the uppermost graph, a “Y-axis” parameter is represented in the center graph, and a “Z-axis” parameter is represented in the lowermost graph. The vertical axis of each graph is a scale that indicates the magnitude of the corresponding parameter at a particular time. X, Y and Z are labels given to the axes of a three-axis coordinate system that plots these parameters against one another. In one embodiment of the invention,

(1) X is an independent variable relative to time, and is a horizontal axis;

(2) Y is a dependent variable relative to magnitude of direction of each of the axes, and is a vertical axis; and

(3) Z is a dependent variable relative to acceleration and amplitude of X and Y, and is an axis orthogonal to both X and Y.

In certain embodiments, the firearm telematics sensor is configured to measure, capture, and transmit information relating to the slightest movement of the firearm in the three spatial dimensions (denoted X, Y, and Z herein) over the course of time. The present invention involves determining and measuring any changes in the position and orientation of the firearm during three distinct timeframes: prior to (e.g., in anticipation of) firing the firearm, the firing of the firearm (the firing event), and subsequent to (e.g., immediately after) the firing event. We call the information captured during these time periods the “trigger pull associated telemetry.”

In this example, the trigger pull telemetry is a three-axis waveform, which is a byproduct of digital transmission, and includes the digital interpretation of finger discipline toward controlling the recoil or flipping motion associated with the firing of a firearm. The finger trigger motion just prior to and during the squeezing of a firearm trigger is measured as an event (acceleration over time), which appears as an impulse of energy followed by a three-axis waveform.

To understand the methods of the present invention, assume, for example, 100 different users of the same firearm, with each user firing the firearm at the same target (or similar targets) under similar circumstances. Assume that firearm telemetry for each firing event is captured and relayed to a central facility separately by the sensor circuitry as trigger pull telemetry. The trigger pull telemetry (e.g., the three-axis trigger pull fingerprints) for each user is then stored in a database. Each instance of trigger pull telemetry is stored so as to be associated with the identity of the user whose trigger pull fingerprint it is.

Now assume that any one of the 100 users again fired the same firearm, but this time did so anonymously. In this example the newly captured trigger pull telemetry is evaluated against the database of previously captured trigger pull telemetry to identify a matching three-axis trigger pull fingerprint. Such matching may involve a least squares analysis or similar form of graphical analysis to identify the trigger pull fingerprint from the database most closely matching the anonymous trigger pull fingerprint.

Further, if the trigger pull fingerprint associated with an anonymous user is determined to not match any of the trigger pull fingerprints stored in the database, the lack of a match can be used as evidence to demonstrate that none of the users registered in the database fired the firearm.

The foregoing description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” and the like are used merely as labels, and are not intended to impose numerical requirements on their objects.

What is claimed is:

1. A system for identifying the individual who discharged a firearm, comprising:
a local system comprising:
the firearm; and
one or more telematics sensors associated with the firearm, wherein the one or more telematics sensors are configured to detect a plurality of inertial measurements; and
a database comprising a plurality of firearm signatures; and
a server comprising one or more memories storing instructions and one or more processors that execute the instructions by:
evaluating the similarity between a test firearm signature based the inertial measurements detected by the one or more telematics sensors and the plurality of firearm signatures of the database;
providing the one or more most similar firearm signatures of the plurality of firearm signatures, or a negative report if none of the plurality of firearm signatures are more similar than a threshold.

3. The system of claim 1, the local system further comprising a mobile device, wherein the mobile device is in communication with the one or more telematics sensors via a personal area network.

4. The system of claim 3, wherein the mobile device is configured to execute the instructions.

5. The system of claim 3, wherein a remote server is configured to execute the instructions.

6. The system of claim 1, the local system further comprising a holster telematics sensor mounted on a holster for the firearm, and wherein the one or more telematics sensors associated with the firearm are activated and begin making inertial measurements when the holster telematics sensor determines that the firearm is unholstered.

7. The system of claim 1, wherein the one or more telematics sensors are further configured to identify an event comprising the discharge of the firearm, and wherein the instructions further include associating the event with one or more of the group selected from: a geographic location of the event, and the direction of aim for the firearm.

8. The system of claim 1, wherein the database further comprises data concerning firing events associated with a firearm operator, wherein the data include firearm bearing and geographic location.

9. A method for identifying the individual who discharged a firearm, comprising:
generating a test firearm signature based on inertial measurements detected by one or more telematics sensors associated with the firearm;
evaluating the similarity between the test firearm signature and a plurality of firearm signatures stored in a database;
providing the one or more most similar firearm signatures of the plurality of firearm signatures, or a negative report if none of the plurality of firearm signatures are more similar than a threshold.

10. The method of claim 9, wherein the test firearm signature is a set of three waveforms corresponding to a time period encompassing a trigger pull and discharge of the firearm.

11. The method of claim 10, wherein the three waveforms represent movements within three spatial axes.

12. The method of claim 11, wherein the inertial measurements are filtered with a band pass filter in order to generate the test firearm signature.

13. The method of claim 9, wherein the similarity is determined using a least-squares comparison, principal component analysis, or Pearson correlation.

14. The method of claim 10, wherein the time period and corresponding waveform data are segmented into: prior to discharge, discharge, and subsequent to discharge.

15. The method of claim 11, wherein the three waveforms are based upon linear acceleration along three spatial axes.

16. The method of claim 11, wherein the three waveforms are based upon rotation about three spatial axes.

17. The method of claim 11, wherein the three waveforms are based upon a combination of acceleration and rotation with respect to three spatial axes.
